(19) United States
(12) Patent Application Publication
(10) Pub. No.: US 2026/0052416 A1
(43) Pub. Date: Feb. 19, 2026

(54) Self-Organizing Networks (SON) and Minimization of Drive Test (MDT) Enhancements for NR-U

(71) Applicant: Apple Inc., Cupertino, CA (US)

(72) Inventors: Alexander SIROTKIN, Hod Hasharon (IL); Fangli XU, Beijing (CN); Haijing HU, Los Gatos, CA (US); Peng CHENG, Beijing (CN); Ping-Heng KUO, London (GB); Ralf ROSSBACH, Munich (DE); Yuqin CHEN, Beijing (CN)

(21) Appl. No.: 19/101,694

(22) PCT Filed: Aug. 8, 2023
(86) PCT No.: PCT/US2023/029686

§ 371 Date: Feb. 6, 2025

Related U.S. Application Data
(60) Provisional application No. 63/370,704, filed on Aug. 8, 2022.

(51) Int. Cl. H04W 24/10; H04W 24/08; H04W 74/0808

(52) U.S. Cl. CPC H04W 24/10; H04W 24/08; H04W 74/0808

(57) ABSTRACT

A user equipment (UE) configured to decode, from signals received from a network, a configuration to perform mobility measurements and log mobility information for reporting to a network in a self-organizing network (SON) or minimization of drive test (MDT) configuration, perform the mobility measurements on a cell operating on unlicensed channels, log the mobility information for the cell, wherein the mobility information for the cell operating on the unlicensed channels includes parameters related to a listen-before-talk (LBT) procedure performed by the UE to access the unlicensed channels, decode, from signals received from the network, a request to report the logged mobility information and configure transceiver circuitry to transmit the logged mobility information including the parameters related to the LBT procedure performed by the UE to access the unlicensed channels of the cell.

### PRIORITY/INCORPORATION BY REFERENCE

This application claims priority to U.S. Provisional Application Serial No. 63/370, 704 filed on Aug. 8, 2022 and entitled “Self-Organizing Networks (SON) and Minimization of Drive Test (MDT) Enhancements for NR-U,” the entirety of which is incorporated herein by reference.

### BACKGROUND

A user equipment (UE) may establish a connection to at least one of a plurality of different networks or types of networks, for example a 5G New Radio (NR) radio access network (RAN). In some scenarios, the RAN can configure the UE to measure, log and report certain types of information, e.g., mobility information, for various reasons. In one example, the RAN may be operating as a self-organizing network (SON) where some network functions are automated across cells of the network. In another example, the RAN may be performing minimization of drive test (MDT) operations to determine information, e.g., location and channel measurements, that would otherwise be gathered via a manual drive test.

During normal operation, a UE can encounter different radio conditions on different cells (and types of cells) that can be logged and reported to the network. Some of the cells included in the measurements/information can be cells operating on unlicensed channels, e.g., NR Unlicensed (NR-U) cells. To access an NR-U cell, the UE may perform a listen-before-talk (LBT) operation to sense the unlicensed channel before attempting a transmission. However, current specifications for measurement/reporting in SON or MDT configurations do not include NR-U related information such as LBT information.

### SUMMARY

Some exemplary embodiments are related to an apparatus of a user equipment (UE), the apparatus having processing circuitry configured to decode, from signals received from a network, a configuration to perform mobility measurements and log mobility information for reporting to a network in a self-organizing network (SON) or minimization of drive test (MDT) configuration, perform the mobility measurements on a cell operating on unlicensed channels, log the mobility information for the cell, wherein the mobility information for the cell operating on the unlicensed channels includes parameters related to a listen-before-talk (LBT) procedure performed by the UE to access the unlicensed channels, decode, from signals received from the network, a request to report the logged mobility information and configure transceiver circuitry to transmit the logged mobility information including the parameters related to the LBT procedure performed by the UE to access the unlicensed channels of the cell.

Other exemplary embodiments are related to a processor configured to decode, from signals received from a network, a configuration to perform mobility measurements and log mobility information for reporting to a network in a self-organizing network (SON) or minimization of drive test (MDT) configuration, perform the mobility measurements on a cell operating on unlicensed channels, log the mobility information for the cell, wherein the mobility information for the cell operating on the unlicensed channels includes parameters related to a listen-before-talk (LBT) procedure performed by the UE to access the unlicensed channels, decode, from signals received from the network, a request to report the logged mobility information and configure transceiver circuitry to transmit the logged mobility information including the parameters related to the LBT procedure performed by the UE to access the unlicensed channels of the cell.

Still further exemplary embodiments are related to an apparatus of a base station, the apparatus having processing circuitry configured to configure transceiver circuitry to transmit a configuration to a user equipment (UE) to perform mobility measurements and log mobility information for reporting to the base station in a self-organizing network (SON) or minimization of drive test (MDT) configuration, wherein the UE performs the mobility measurements on a cell operating on unlicensed channels and logs the mobility information for the cell, wherein the mobility information for the cell operating on the unlicensed channels includes parameters related to a listen before talk (LBT) procedure performed by the UE to access the unlicensed channels, configure transceiver circuitry to transmit a request to the UE to report the logged mobility information and decode, from signaling received from the UE, a report for the logged mobility information including the parameters related to the listen-before-talk (LBT) procedure performed by the UE to access the unlicensed channels of the cell.

Additional exemplary embodiments are related to a processor configured to configure transceiver circuitry to transmit a configuration to a user equipment (UE) to perform mobility measurements and log mobility information for reporting to the base station in a self-organizing network (SON) or minimization of drive test (MDT) configuration, wherein the UE performs the mobility measurements on a cell operating on unlicensed channels and logs the mobility information for the cell, wherein the mobility information for the cell operating on the unlicensed channels includes parameters related to a listen before talk (LBT) procedure performed by the UE to access the unlicensed channels, configure transceiver circuitry to transmit a request to the UE to report the logged mobility information and decode, from signaling received from the UE, a report for the logged mobility information including the parameters related to the listen-before-talk (LBT) procedure performed by the UE to access the unlicensed channels of the cell.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a network arrangement including a UE in a network deployment with a serving cell and a neighbor cell according to various exemplary embodiments.

FIG. 5 shows a method for reporting mobility-related measurements/information for a NR-U cell according to various exemplary embodiments.

### DETAILED DESCRIPTION

The exemplary embodiments may be further understood with reference to the following description and the related appended drawings, wherein like elements are provided with the same reference numerals. The exemplary embodiments relate to operations for a user equipment (UE) to report to a radio access network (RAN), e.g., the 5G New Radio (NR) RAN, mobility-related information for a cell or node operating on unlicensed channels, e.g., an NR Unlicensed (NR-U) cell. The mobility-related information can comprise logged information reported to the RAN where the RAN is operating as a self-organizing network (SON) or performing minimization of drive test (MDT) operations.

According to some aspects, the mobility-related information can be logged based on a network configuration for reporting, e.g., a radio link failure (RLF), a connection establishment failure (CEF), a successful handover (SHO), mobility history, or logged measurements. For each of these measurement/reporting configurations, the UE can be further configured to include NR-U related information for NR-U cells included in the measurements, e.g., visited by the UE (as a serving cell) or measured as a neighbor cell. In some embodiments, the reporting can be triggered when an event, e.g., RLF, CEF, or SHO, occurs to a UE in the radio resource control (RRC) CONNECTED state. In other embodiments, the measurements can be performed in the RRC IDLE state and/or reported less often.

According to further aspects, the measurements/information for the NR-U cells/nodes can include an indicator that the cell is an NR-U cell, a channel access mode, a Received Signal Strength Indicator (RSSI), a RSSI measurement timing configuration, a channel occupancy (CO), and/or an indication of whether a neighbor NR-U cell belongs to the same public land mobile network (PLMN) as a serving cell. In further aspects, the measurements/information for the NR-U cells/nodes can further include detailed listen-before-talk (LBT) related information for an LBT process performed by the UE to access the NR-U cell. Additional measurements/information can also be provided, to be described in greater detail below.

The exemplary embodiments are described with regard to a UE. Those skilled in the art will understand that the UE may be any type of electronic component that is configured to communicate via a network, e.g., mobile phones, tablet computers, desktop computers, smartphones, phablets, embedded devices, wearables, Internet of Things (IoT) devices, etc., and is configured with the hardware, software, and/or firmware to exchange information and data with the network Therefore, the UE as described herein is used to represent any electronic component that directly communicates with the network.

The exemplary embodiments are also described with regard to a 5G New Radio (NR) radio access network (RAN). However, reference to a 5G NR RAN is merely provided for illustrative purposes. The exemplary embodiments may be utilized with any network implementing measurement and reporting functionalities similar to those described herein. Therefore, the 5G NR network as described herein may represent any type of network implementing measurement and reporting functionalities similar to the 5G NR network.

In the 5G NR standards, NR-U relates to the management of the unlicensed (shared) spectrum. NR-U may also be utilized in a standalone (SA) configuration, where a single NR cell provides an unlicensed bandwidth for data transmissions, or in a non-standalone (NSA) configuration, e.g., where an NR-U cell is included in a secondary cell group (SCG) of a dual-connectivity (DC) configuration. NR-U is designed to maintain fair coexistence with other incumbent technologies using the shared spectrum and uses a listen-before-talk (LBT) procedure to acquire the (unlicensed) medium before a transmission. An LBT such as a clear channel assessment (CCA) may be performed to sense the channel. The UE can detect the energy level on multiple sub-bands of the channel based on configured LBT parameters including type, duration, channel occupancy (CO) parameters, CCA parameters, etc.

The exemplary embodiments are also described with regard to self-organizing networks (SON). Those skilled in the art understand that a SON refers to a network that automates certain network functions across cells or nodes of the network. The automated functions may include, e.g., configuration of cells/nodes, optimization of operating parameters, healing of network issues, and security for the network. These functions may be performed in view of measurements/information provided from cells/nodes across the network and from user devices serviced by the network including, e.g., mobility data. However, reference to any particular SON function is for exemplary purposes only and the SON may use such information for any of a variety of functions.

The exemplary embodiments are also described with regard to minimization of test drive (MDT). Those skilled in the art understand that MDT refers to 3GPP techniques to minimize the need for manual drive tests to be performed by collecting mobility data from devices deployed in the network. For example, UEs can be configured to collect and report mobility data, e.g., location and channel measurements, to the network for further analysis. However, reference to any particular use of the mobility data for MDT functionalities is for exemplary purposes only and the MDT may use such information for any of a variety of purposes.

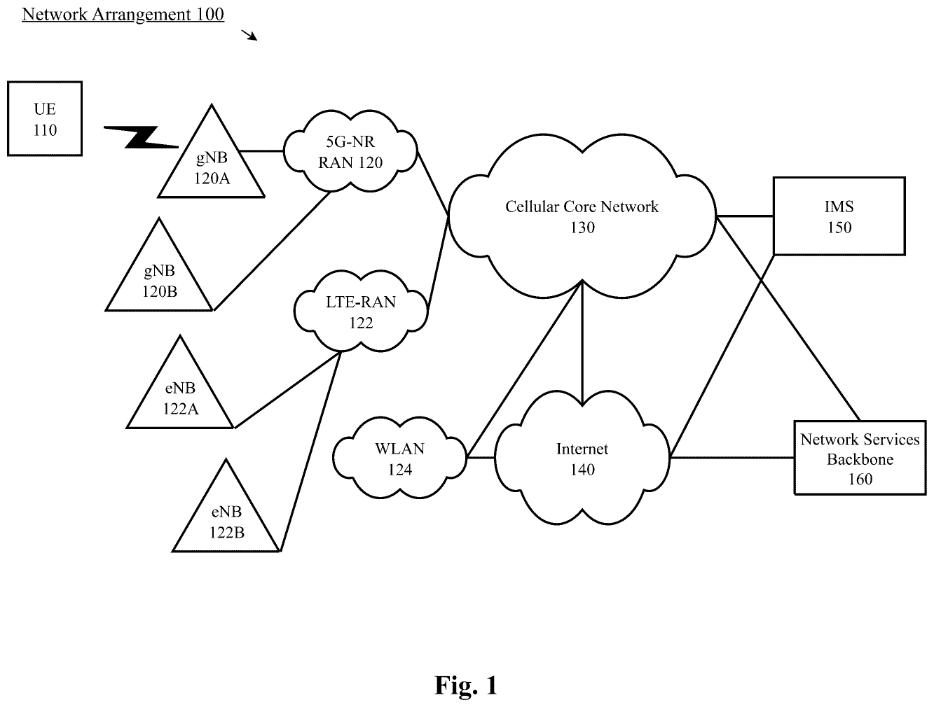

FIG. 1 shows an exemplary network arrangement 100 according to various exemplary embodiments. The exemplary network arrangement 100 includes a user equipment (UE) 110. Those skilled in the art will understand that the UE may be any type of electronic component that is configured to communicate via a network, e.g., mobile phones, tablet computers, smartphones, phablets, embedded devices, wearable devices, Cat-M devices, Cat-M1 devices, MTC devices, eMTC devices, other types of Internet of Things (IoT) devices, etc. It should also be understood that an actual network arrangement may include any number of UEs being used by any number of users. Thus, the example of a single UE 110 is merely provided for illustrative purposes.

The UE 110 may communicate directly with one or more networks. In the example of the network configuration 100, the networks with which the UE 110 may wirelessly communicate are a 5G NR radio access network (5G NR-RAN) 120, an LTE radio access network (LTE-RAN) 122 and a wireless local access network (WLAN) 124. Therefore, the UE 110 may include a 5G NR chipset to communicate with the 5G NR-RAN 120, an LTE chipset to communicate with the LTE-RAN 122 and an ISM chipset to communicate with the WLAN 124. However, the UE 110 may also communicate with other types of networks (e.g., legacy cellular networks) and the UE 110 may also communicate with networks over a wired connection. With regard to the exemplary aspects, the UE 110 may establish a connection with the 5G NR-RAN 120 and the LTE-RAN 122 in a NSA or DC mode of operation.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UE 110 may connect to the 5G NR-RAN 120 via at least one of the next generation nodeB (gNB) 120A and/or the gNB 120B. Reference to two gNBs 120A, 120B is merely for illustrative purposes. The exemplary aspects may apply to any appropriate number of gNBs. The UE 110 may additionally connect to the LTE-RAN 122 via at least one of the enhanced nodeB (eNB) 122A and/or the eNB 122B. Reference to two eNBs 122A, 122B is merely for illustrative purposes. The exemplary aspects may apply to any appropriate number of eNBs.

In addition to the networks 120, 122 and 124 the network arrangement 100 also includes a cellular core network 130, the Internet 140, an IP Multimedia Subsystem (IMS) 150, and a network services backbone 160. The cellular core network 130, e.g., the 5GC for the 5G NR network, may be considered to be the interconnected set of components that manages the operation and traffic of the cellular network. The cellular core network 130 also manages the traffic that flows between the cellular network and the Internet 140.

The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

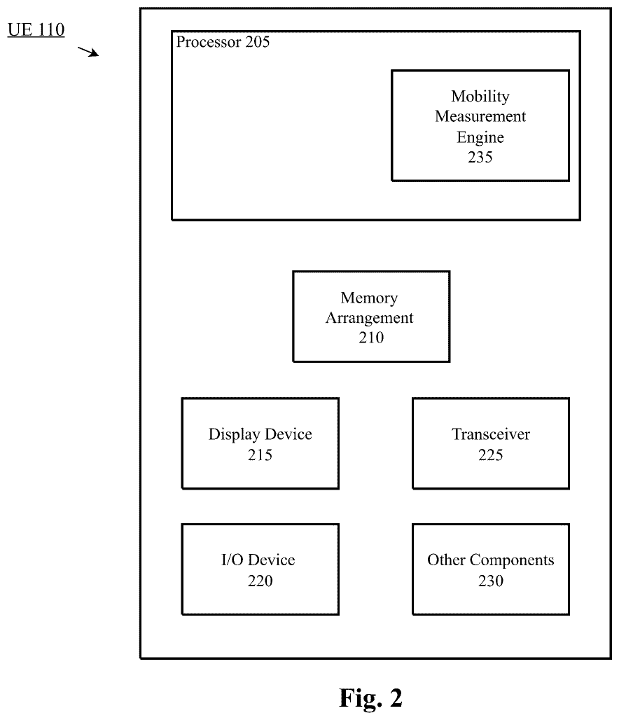

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc. Additionally, the UE 110 may be configured to access an SNPN.

The processor 205 may be configured to execute a plurality of engines for the UE 110. For example, the engines may include a mobility measurement engine 235 for performing operations related to receiving a configuration from the network for performing measurements, logging and reporting of mobility related measurements/information to the RAN, e.g., a RAN operating as a SON or performing MDT operations. The mobility measurement engine 235 can further include NR-U related information in the reports. These and further operations will be described in greater detail below.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary aspects may be implemented in any of these or other configurations of a UE.

The memory 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G-NR RAN 120, the LTE RAN 122 etc. Accordingly, the transceiver 225 may operate on a variety of different frequencies or channels (e.g., set of consecutive frequencies). The transceiver 225 may encompass an advanced receiver (e.g., E-MMSE-RC, R-ML, etc.) for MU-MIMO. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

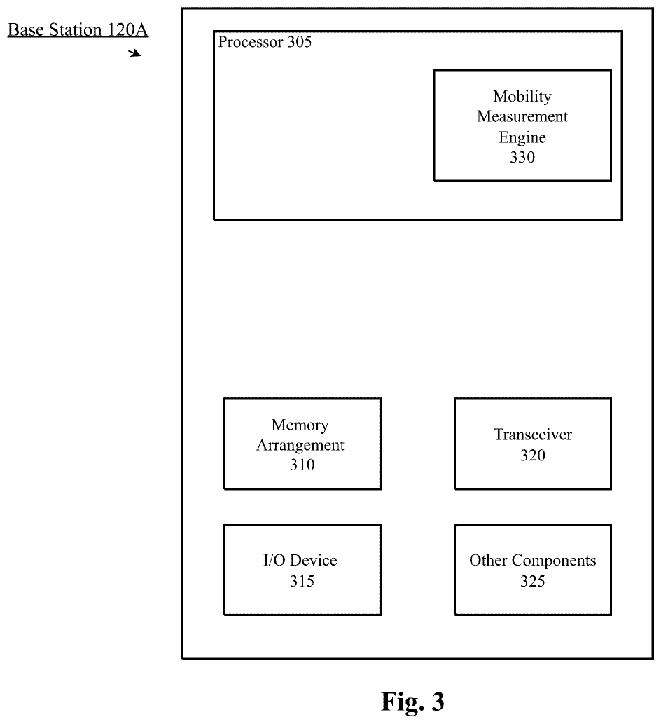

FIG. 3 shows an exemplary network base station, in this case gNB 120A, according to various exemplary embodiments. As noted above with regard to the UE 110, the gNB 120A may represent a serving cell for the UE 110. The gNB 120A may represent any access node of the 5G NR network through which the UE 110 may establish a connection and manage network operations. The gNB 120A illustrated in FIG. 3 may also represent the gNB 120B.

The gNB 120A may include a processor 305, a memory arrangement 310, an input/output (I/O) device 320, a transceiver 325, and other components 330. The other components 330 may include, for example, an audio input device, an audio output device, a battery, a data acquisition device, ports to electrically connect the gNB 120A to other electronic devices, etc.

The processor 305 may be configured to execute a plurality of engines of the gNB 120A. For example, the engines may include a mobility measurement engine 330 for performing operations including configuring a UE to measure, log and report mobility related measurements/information to the gNB 120, e.g., a cell in a RAN operating as a SON or performing MDT operations. The UE can be further configured to include NR-U related information in the reports. These and further operations will be described in greater detail below.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.) . The exemplary embodiments may be implemented in any of these or other configurations of a base station.

The memory 310 may be a hardware component configured to store data related to operations performed by the UEs 110, 112. The I/O device 320 may be a hardware component or ports that enable a user to interact with the gNB 120A. The transceiver 325 may be a hardware component configured to exchange data with the UE 110 and any other UE in the system 100.

The transceiver 325 may operate on a variety of different frequencies or channels (e.g., set of consecutive frequencies). Therefore, the transceiver 325 may include one or more components (e.g., radios) to enable the data exchange with the various networks and UEs. The transceiver 325 includes circuitry configured to transmit and/or receive signals (e.g., control signals, data signals). Such signals may be encoded with information implementing any one of the methods described herein. The processor 305 may be operably coupled to the transceiver 325 and configured to receive from and/or transmit signals to the transceiver 325. The processor 305 may be configured to encode and/or decode signals (e.g., signaling from a UE) for implementing any one of the methods described herein.

A self-organizing network (SON) refers to a radio access network (RAN) that automates network functions across cells of the RAN including, e.g., configuration, optimization, healing and security, that previously required manual intervention (e.g., technicians). The SON uses information received from the various cells and applies optimization algorithms (e.g., artificial intelligence) to coordinate the operation of the cells to provide optimal coverage to user equipment (UE) serviced by the RAN.

The SON can detect and register new cells added to the RAN. The operating parameters for the cells, e.g., operating frequencies, emission power, etc., can be adjusted in coordination to, e.g., minimize interference and enhance coverage/capacity. High congestion scenarios can be similarly managed, and the SON can adapt to provide coverage in an area where, e.g., a cell fails. Further, the SON can spread security information throughout the RAN to, e.g., protect the RAN from external attack.

In a centralized SON, the network optimization functions are centralized at higher-order cells, from which control messages, e.g., commands, requests, etc., are propagated to the lower-order cells. In a distributed SON, commands are distributed across the network and each node interacts with its neighbor cells. A hybrid SON refers to a combination of centralized and distributed SON.

Minimization of drive test (mdt) refers to 3GPP techniques where UEs are used to collect and report mobility data, e.g., location and channel measurements, to minimize the need for manual drive tests to be performed to collect this data. The MDT techniques can provide measurements for coverage areas where drive tests would typically be performed but can further include measurements for areas inaccessible by vehicle. The UE can provide MDT measurements in the RRC CONNECTED state or the RRC IDLE/INACTIVE state. For the IDLE/INACTIVE state, measurements can be taken and reported later (e.g., when the UE enters the CONNECTED state). The measurements are transmitted to a RAN node and routed to a trace collection entity (TCE).

The UE can be configured to measure, log and report various types of mobility-related information for SON and/or MDT purposes, e.g., information regarding radio measurements for various cells encountered by the UE, events of interest, mobility, etc.

The logging of mobility information (e.g., error information) for various SON features is typically a UE capability. If supported by the UE, when the UE encounters an event of interest (e.g., radio link failure (RLF) ), the UE stores the relevant information in an internal variable (e.g., VarRLF-Report). If the UE has logged SON information, it indicates its availability to the network by including the UEMeasurementsAvailable IE in an UL RRC message (e.g., RRCReestablishmentComplete, RRCReconfigurationComplete, RRCResumeComplete, or RRCSetupComplete). The network can then request the UE to provide the logged information using the UEInformationRequest message. If requested, the UE provides the requested SON information in UEInformationResponse. The UE in the SON configuration can report measurement information to the network via various mechanisms, including, e.g., a radio link failure (RLF) report; a connection establishment failure (CEF) report; a successful handover (SHO) report; a mobility history report; and/or other types of reports. It should be understood that the above described parameters and message names are only exemplary and the exemplary embodiments are not required to use parameters and messages that are similarly named.

In MDT, similar to SON, MDT measurements can be retrieved by the network using the UEInformationRequest and UEInformationResponse mechanism. The availability of mobility information is indicated to the network in a similar way. In contrast to SON, MDT measurements are configured using a separate procedure, e.g., LoggedMeasurementConfiguration.

Another difference is that MDT measurements are performed in both IDLE and CONNECTED (typically over longer periods of time than SON). The UE in the MDT configuration can report measurement information to the network using the LogMeasurementReport. It should be understood that the above described parameters and message names are only exemplary and the exemplary embodiments are not required to use parameters and messages that are similarly named.

SON was first introduced in Rel-16 and further enhanced in Rel-17. As new features are being defined in 3GPP Rel-18, SON can be enhanced to allow operators to troubleshoot and fine tune these new features, including NR Unlicensed (NR-U).

In the 5G NR standards, NR-U relates to the management of the unlicensed (shared) spectrum. NR-U may also be utilized in a standalone configuration, where a single NR-U cell provides an unlicensed bandwidth for data transmissions, or in a non-standalone configuration, e.g., where an NR-U cell is included in a secondary cell group (SCG) of a dual-connectivity (DC) configuration. NR-U is designed to maintain fair coexistence with other incumbent technologies using the shared spectrum and uses a listen-before-talk (LBT) procedure to acquire the (unlicensed) medium before a transmission can occur.

A UE may support NR-U operation, which is also referred to as LBT operation or shared spectrum channel access. The NR-U cell (e.g., gNB) operates in either dynamic or semi-static channel access mode as described in TS 37.213. Channel access procedures based on semi-static channel occupancy, are intended for environments where the absence of other technologies is guaranteed, e.g., by level of regulations, private premises policies, etc. In both channel access modes, the gNB and UE may apply LBT before performing a transmission on a cell configured with shared spectrum channel access. When LBT is applied, the transmitter listens to/senses the channel to determine whether the channel is free or busy and performs transmission only if the channel is sensed free. An LBT such as a clear channel assessment (CCA) may be performed to sense the channel. The UE can detect the energy level on multiple sub-bands of the channel based on configured LBT parameters including type, duration, channel occupancy (CO) parameters, CCA parameters, etc.

According to various exemplary embodiments described herein, mobility-related information can be reported by the UE to the network for a cell or node operating on unlicensed channels, e.g., an NR Unlicensed (NR-U) cell. The network may be a self-organizing network (SON), or the mobility-related information can be reported for minimization of drive test (MDT) purposes.

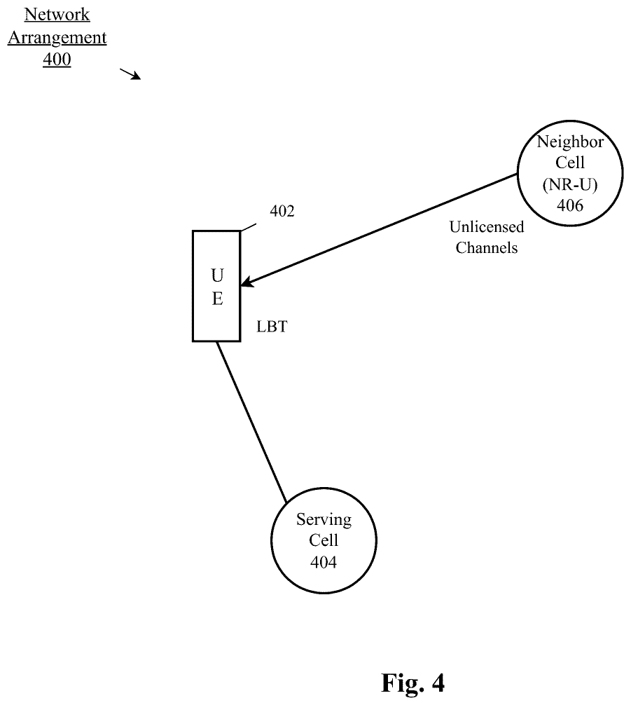

FIG. 4 shows a network arrangement 400 including a UE 402 in a network deployment with a serving cell 404 and a neighbor cell 406 according to various exemplary embodiments. In this example, the serving cell 404 does not operate on unlicensed channels (e.g., is not a NR-U node) and the neighbor cell 406 operates on unlicensed channels (e.g., is a NR-U node). However, in other network deployments, the serving cell 404 can be an NR-U cell.

The UE 402 is configured for the measurement, logging and reporting of mobility-related information. The serving cell 404 and the neighbor cell 406 may be cells in a self-organizing network (SON). The configuration may also be for minimization of drive test (MDT) purposes.

The UE 402 may attempt to access the neighbor (NR-U) cell 406 and/or may perform radio measurements on the (unlicensed) operating frequencies of the NR-U cell 406. For example, the UE 402 may perform measurements for the NR-U cell 406 in an attempt to handover to the NR-U cell 406, perform mobility measurements, or log measurements for MDT. The UE 402 performs an LBT procedure for NR-U cells.

A number of events can occur for the UE 402 with regard to the NR-U cell 404, including, e.g., radio link failure, where the NR-U cell 404 comprises any one of a failed cell, previous cell, or reconnect cell; a connection establishment failure (CEF), where the NR-U cell 404 comprises a failed cell or a neighbor cell; or a successful handover (SHO), where the NR-U cell 404 comprises a source cell, a target cell or a neighbor cell. The UE 402 can further measure the NR-U cell 406 for mobility history as a visited cell and/or for MDT as a serving cell, neighbor cell, etc.

The UE 402 uses the LBT procedure to acquire the unlicensed channel of the NR-U cell 406. The UE 402 can detect the energy level on multiple sub-bands of the channel based on configured LBT parameters including type, duration, channel occupancy (CO) parameters, CCA parameters, etc.

According to various exemplary embodiments, the UE 402 can be configured to log and report NR-U related information in a report to the RAN, e.g., for SON or MDT. In some embodiments, the reporting can be triggered when an event, e.g., RLF, CEF, or SHO, occurs to a UE in the radio resource control (RRC) CONNECTED state, while in other embodiments, the measurements can be performed in the RRC IDLE state and/or reported less often.

The NR-U related information can include, e.g., an indicator that the cell is NR-U; a channel access mode, e.g., dynamic or semi-static; a Received Signal Strength Indicator (RSSI), a RSSI measurement timing configuration, a channel occupancy (CO), and/or an indication of whether a neighbor NR-U cell belongs to the same public land mobile network (PLMN) as a serving cell. The NR-U related information can further include detailed LBT related information for an LBT process performed by the UE to access the NR-U cell. The LBT information can include, e.g., an LBT counter (LBT_COUNTER) of the connection attempts in the NR-U cell (applicable to serving cells). The LBT information can further include an indication of whether the LBT_COUNTER is above a configured threshold (if applicable). The LBT information can further include a Channel Access Priority Class (CAPC) (if applicable). The CAPCs were defined to provide differentiated quality of service in unlicensed operation. The LBT information can further include a number of autonomous (re)transmissions that were performed (if applicable).

In one aspect of these exemplary embodiments, NR-U related information can be provided for a NR-U cell in a radio link failure (RLF) report. The RLF report includes information for a failed cell, a previous cell and a reconnect cell, any one of which could be a NR-U cell.

A serving gNB can configure a UE for radio link monitoring (RLM) and/or beam failure detection (BFD) using a RadioLinkMonitoringConfig information element including parameters for detection resources (e.g., RLM reference signals) to measure for RLM and parameters for declaring radio link failure (RLF), e.g., based on a number of connection failures within a timer duration.

The RLF report carries information about the failed cell (e.g., failedPCellId-r16), the previous cell (e.g., previousPCellIdr16), the reconnect cell (e.g., reconnectCellId-r16), neighbor cells and other information which may help the network to identify the problem.

The RLF report can include NR-U related information including: the indicator that the cell is NR-U; the channel access mode, e.g., dynamic or semi-static; RSSI; RSSI measurement timing configuration; CO; the indication of whether the NR-U cell (neighbor cell) belongs to the same public land mobile network (PLMN) as the serving cell; and/or detailed LBT related information, as described above.

When the RLF event occurs, the UE stores/logs the information for the NR-U cell in in an internal variable (e.g., VarRLF-Report) for reporting to the RAN. New IEs can be defined for the NR-U related information to be included in RLF-Report.

In another aspect of these exemplary embodiments, the NR-U related information can be provided for a NR-U cell in a connection establishment failure (CEF) report. The CEF report includes information for a failed cell and a neighbor cell, either one of which could be a NR-U cell.

When performing cell selection, if no suitable or acceptable cell can be found, CEF may be declared based on configured CEF control parameters including, e.g., a fail count (a number of times the UE detects expiry of the T300 timer). The CEF report carries information about the failed cell (e.g., failedPCellId-r16), neighbor cells and other information which may help the network to identify the problem.

The CEF report can include NR-U related information including: the indicator that the cell is NR-U; the channel access mode, e.g., dynamic or semi-static; RSSI; RSSI measurement timing configuration; CO; the indication of whether the NR-U cell (neighbor cell) belongs to the same public land mobile network (PLMN) as the serving cell; and/or detailed LBT related information, as described above.

The CEF report can additionally include an indication of whether CEF was declared due to consistent LBT failure. Currently, consistent LBT failure (LBT_COUNTER>configured threshold) is defined for connected mode only, however, a similar definition can also be applied for connection establishment and thus can be reported for CEF.

When the CEF event occurs, the UE stores/logs the information for the NR-U cell in in an internal variable (e.g., VarConnEstFailReport) for reporting to the RAN. New IEs can be defined for the NR-U related information to be included in the ConnEstFailReport.

In still another aspect of these exemplary embodiments, the NR-U related information can be provided for a NR-U cell in a successful handover (SHO) report. The SHO report includes information for a source cell, a target cell, and neighbor cells, any one of which could be a NR-U cell. The SHO report can help the network to identify a potentially suboptimal configuration, even though the handover was successful (no failure generated).

The SHO report can include NR-U related information including: the indicator that the cell is NR-U; the channel access mode, e.g., dynamic or semi-static; RSSI; RSSI measurement timing configuration; CO; the indication of whether the NR-U cell (neighbor cell) belongs to the same public land mobile network (PLMN) as the serving cell; and/or detailed LBT related information, as described above.

When the SHO event occurs, the UE stores/logs the information for the NR-U cell in in an internal variable (e.g., VarSuccessHO-Report) for reporting to the RAN. New IEs can be defined for the NR-U related information to be included in the SuccessHO-Report-r17.

In still another aspect of these exemplary embodiments, the NR-U related information can be provided for a NR-U cell in a mobility report. The mobility report includes information for visited cells of the UE including, e.g., a cell global identity (CGI), a physical cell ID (PCI), a carrier frequency, etc.

The mobility report can include NR-U related information including: the indicator that the cell is NR-U; and/or the channel access mode, e.g., dynamic or semi-static.

When the UE visits a cell, the UE stores/logs the information for the NR-U cell in in an internal variable (e.g., VarMobilityHistoryReport) for reporting to the RAN. New IEs can be defined for the NR-U related information to be included in the MobilityHistoryReport.

In still another aspect of these exemplary embodiments, the NR-U related information can be provided for a NR-U cell in a logged measurement report for MDT. The logged measurement report includes information for a serving cell or a neighbor cell, any one of which could be a NR-U cell.

MDT is different from SON as a UE collects MDT information over longer periods of time, including when the UE is in RRC IDLE. MDT also uses different signaling, e.g., LogMeasReport.

The logged measurement report can include NR-U related information including: the indicator that the cell is NR-U; the channel access mode, e.g., dynamic or semi-static; RSSI; RSSI measurement timing configuration; CO; the indication of whether the NR-U cell (neighbor cell) belongs to the same public land mobile network (PLMN) as the serving cell; and/or detailed LBT related information, as described above.

The logged measurement report can additionally include an indication of whether the camped cell is the non-best NR-U cell for camping. In NR-U cell reselection, the UE can camp on a non-best cell if the best cell does not belong to the registered PLMN (or E-PLMN), where the non-best cell would still be the best cell of the registered PLMN.

The UE stores/logs the information for the NR-U cell in in an internal variable (e.g., VarLogMeasReport) for reporting to the RAN. New IEs can be defined for the NR-U related information to be included in the LogMeasReport.

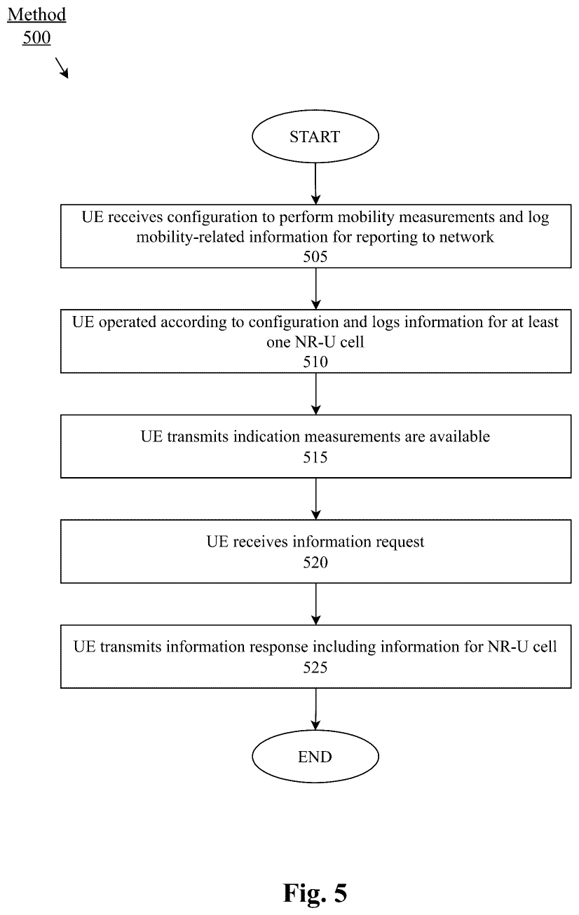

FIG. 5 shows a method 500 for reporting mobility-related measurements/information for a NR-U cell according to various exemplary embodiments. The NR-U cell could be a serving cell or a neighbor cell operating on unlicensed channels. The NR-U cell may be a cell in a self-organizing network (SON) or involved in minimization of drive test (MDT) operations.

In 505, the UE receives a configuration from the network to perform mobility measurements and store (log) mobility-related information for reporting to the network. The UE is configured to log mobility information including, e.g., channel measurements for serving cells and/or neighbor cells (e.g., logged measurements) ; events of interest including failed handover, connection establishment failure, and/or successful handover; and mobility history. According to the exemplary embodiments described herein, the UE is further configured to store NR-U related measurements/information when the UE visits an NR-U cell, e.g., as serving cell or a neighbor cell in a secondary cell group (SCG).

In 510, the UE operates according to the configuration and logs channel measurements, the occurrence of events, etc., e.g., in a mobility scenario. The UE may log different types of events. It should be understood that some types of event logging trigger the UE to indicate the availability of the information, while in other configurations the UE may log information for periodic reporting.

The UE may attempt to access the neighbor (NR-U) cell and/or may perform radio measurements on the (unlicensed) operating frequencies of the NR-U cell. For example, the UE 402 may perform measurements for the NR-U cell in an attempt to handover to the NR-U cell, perform mobility measurements, or log measurements for MDT. The UE performs an LBT procedure for NR-U cells. The UE can detect the energy level on multiple sub-bands of the channel based on configured LBT parameters including type, duration, channel occupancy (CO) parameters, CCA parameters, etc.

In 515, the UE transmits an indication that measurements are available, e.g., a UEMeasurementsAvailable IE in an UL RRC message. In 520, the UE receives a UEInformationRequest message from the network. In 525, the UE transmits a UEInformationResponse including the logged information for the at least one NR-U cell. The logged information can include various information for the NR-U cell including detailed LBT information.

The serving gNB receiving the UEInformationResponse can, in some embodiments, use the information included therein for SON procedures, e.g., RAN optimization. In other embodiments, the serving gNB routes the information to neighbor nodes or to a higher-order node that execute the SON procedures. In still other embodiments, in MDT operation, the information may be provided to a trace collection entity (TCE).

### EXAMPLES

In a first example, a method performed by a user equipment (UE), comprising receiving a configuration to perform mobility measurements and log mobility information for reporting to a network in a self-organizing network (SON) or minimization of drive test (MDT) configuration, performing the mobility measurements on a cell operating on unlicensed channels, logging the mobility information for the cell, wherein the mobility information for the cell operating on the unlicensed channels includes parameters related to a listen-before-talk (LBT) procedure performed by the UE to access the unlicensed channels, receiving a request to report the logged mobility information and reporting the logged mobility information including the parameters related to the LBT procedure performed by the UE to access the unlicensed channels of the cell.

In a second example, the method of the first example, wherein the logged mobility information for the LBT procedure is included in a radio link failure (RLF) report for the SON configuration, wherein the cell operating on the unlicensed channels is a failed cell, a previous primary cell (PCell), or a reconnect cell in a RLF event.

In a third example, the method of the first example, wherein the logged mobility information for the LBT procedure is included in a connection establishment failure (CEF) report for the SON configuration, wherein the cell operating on the unlicensed channels is a failed cell or a neighbor cell in a CEF event.

In a fourth example, the method of the first example, wherein the logged mobility information for the LBT procedure is included in a successful handover (SHO) report for the SON configuration, wherein the cell operating on the unlicensed channels is a source cell or a target cell in a successful handover event.

In a fifth example, the method of the first example, wherein the logged mobility information for the LBT procedure is included in a mobility history report for the SON configuration, wherein the cell operating on the unlicensed channels is a visited cell of the UE.

In a sixth example, the method of the first example, wherein the logged mobility information for the LBT procedure is included in a log measurement report for the MDT configuration, wherein the cell operating on the unlicensed channels is a serving cell or a neighbor cell of the UE.

In a seventh example, the method of the first example, wherein the logged mobility information includes an indication that the cell operates on the unlicensed channels, a channel access mode used by the cell, a RSSI, a RSSI measurement timing configuration, a channel occupancy, and, when the cell is a neighbor cell, whether the cell belongs to a same or different public land mobile network (PLMN).

In an eighth example, the method of the seventh example, wherein the logged mobility information further includes whether connection establishment failure (CEF) occurred due to consistent LBT failure.

In a ninth example, the method of the seventh example, wherein the logged mobility information further includes whether a serving cell is a non-best cell to access the unlicensed channels.

In a tenth example, the method of the first example, wherein the parameters related to the LBT procedure include a LBT counter of connection attempts in the cell.

In an eleventh example, the method of the first example, wherein the parameters related to the LBT procedure include whether a LBT counter exceeds a configured threshold.

In a twelfth example, the method of the first example, wherein the parameters related to the LBT procedure include a channel access priority class (CAPC).

In a thirteenth example, the method of the first example, wherein the parameters related to the LBT procedure include a number of autonomous transmissions or retransmissions where the LBT was performed.

In a fourteenth example, a processor configured to perform any of the methods of the first through thirteenth examples.

In a fifteenth example, a user equipment (UE) comprising a transceiver configured to communicate with a network and a processor communicatively coupled to the transceiver and configured to perform any of the methods of the first through thirteenth examples.

In a sixteenth example, a method performed by a base station, comprising transmitting a configuration to a user equipment (UE) to perform mobility measurements and log mobility information for reporting to the base station in a self-organizing network (SON) or minimization of drive test (MDT) configuration, wherein the UE performs the mobility measurements on a cell operating on unlicensed channels and logs the mobility information for the cell, wherein the mobility information for the cell operating on the unlicensed channels includes parameters related to a listen before talk (LBT) procedure performed by the UE to access the unlicensed channels, transmitting a request to the UE to report the logged mobility information and receiving a report for the logged mobility information including the parameters related to the listen-before-talk (LBT) procedure performed by the UE to access the unlicensed channels of the cell.

In a seventeenth example, the method of the sixteenth example, wherein the logged mobility information for the LBT procedure is included in a radio link failure (RLF) report for the SON configuration, wherein the cell operating on the unlicensed channels is a failed cell, a previous primary cell (PCell), or a reconnect cell in a RLF event.

In an eighteenth example, the method of the sixteenth example, wherein the logged mobility information for the LBT procedure is included in a connection establishment failure (CEF) report for the SON configuration, wherein the cell operating on the unlicensed channels is a failed cell or a neighbor cell in a CEF event.

In a nineteenth example, the method of the sixteenth example, wherein the logged mobility information for the LBT procedure is included in a successful handover (SHO) report for the SON configuration, wherein the cell operating on the unlicensed channels is a source cell or a target cell in a successful handover event.

In a twentieth example, the method of the sixteenth example, wherein the logged mobility information for the LBT procedure is included in a mobility history report for the SON configuration, wherein the cell operating on the unlicensed channels is a visited cell of the UE.

In a twenty first example, the method of the sixteenth example, wherein the logged mobility information for the LBT procedure is included in a log measurement report for the MDT configuration, wherein the cell operating on the unlicensed channels is a serving cell or a neighbor cell of the UE.

In a twenty second example, the method of the sixteenth example, wherein the logged mobility information includes an indication that the cell operates on the unlicensed channels, a channel access mode used by the cell, a RSSI, a RSSI measurement timing configuration, a channel occupancy, and, when the cell is a neighbor cell, whether the cell belongs to a same or different public land mobile network (PLMN).

In a twenty third example, the method of the twenty second example, wherein the logged mobility information further includes whether connection establishment failure (CEF) occurred due to consistent LBT failure.

In a twenty fourth example, the method of the twenty second example, wherein the logged mobility information further includes whether a serving cell is a non-best cell to access the unlicensed channels.

In a twenty fifth example, the method of the sixteenth example, wherein the parameters related to the LBT procedure include a LBT counter of connection attempts in the cell.

In a twenty sixth example, the method of the sixteenth example, wherein the parameters related to the LBT procedure include whether a LBT counter exceeds a configured threshold.

In a twenty seventh example, the method of the sixteenth example, wherein the parameters related to the LBT procedure include a channel access priority class (CAPC).

In a twenty eighth example, the method of the sixteenth example, wherein the parameters related to the LBT procedure include a number of autonomous transmissions or retransmissions where the LBT was performed.

In a twenty ninth example, a processor configured to perform any of the methods of the sixteenth through twenty eighth examples.

In an thirtieth example, a base station comprising a transceiver configured to communicate with a user equipment (UE) and a processor communicatively coupled to the transceiver and configured to perform any of the methods of the sixteenth through twenty eighth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
decode, from signals received from a network, a configuration to perform mobility measurements and log mobility information for reporting to a network in a self-organizing network (SON) or minimization of drive test (MDT) configuration;
perform the mobility measurements on a cell operating on unlicensed channels;
log the mobility information for the cell, wherein the mobility information for the cell operating on the unlicensed channels includes parameters related to a listen-before-talk (LBT) procedure performed by the UE to access the unlicensed channels;
decode, from signals received from the network, a request to report the logged mobility information; and
configure transceiver circuitry to transmit the logged mobility information including the parameters related to the LBT procedure performed by the UE to access the unlicensed channels of the cell.

2. The apparatus of claim 1, wherein the logged mobility information for the LBT procedure is included in a radio link failure (RLF) report for the SON configuration, wherein the cell operating on the unlicensed channels is a failed cell, a previous primary cell (PCell), or a reconnect cell in a RLF event.

3. The apparatus of claim 1, wherein the logged mobility information for the LBT procedure is included in a connection establishment failure (CEF) report for the SON configuration, wherein the cell operating on the unlicensed channels is a failed cell or a neighbor cell in a CEF event.

4. The apparatus of claim 1, wherein the logged mobility information for the LBT procedure is included in a successful handover (SHO) report for the SON configuration, wherein the cell operating on the unlicensed channels is a source cell or a target cell in a successful handover event.

5. The apparatus of claim 1, wherein the logged mobility information for the LBT procedure is included in a mobility history report for the SON configuration, wherein the cell operating on the unlicensed channels is a visited cell of the UE.

6. The apparatus of claim 1, wherein the logged mobility information for the LBT procedure is included in a log measurement report for the MDT configuration, wherein the cell operating on the unlicensed channels is a serving cell or a neighbor cell of the UE.

7. The apparatus of claim 1, wherein the logged mobility information includes an indication that the cell operates on the unlicensed channels, a channel access mode used by the cell, a RSSI, a RSSI measurement timing configuration, a channel occupancy, and, when the cell is a neighbor cell, whether the cell belongs to a same or different public land mobile network (PLMN).

8. The apparatus of claim 7, wherein the logged mobility information further includes whether connection establishment failure (CEF) occurred due to consistent LBT failure.

9. The apparatus of claim 7, wherein the logged mobility information further includes whether a serving cell is a non-best cell to access the unlicensed channels.

10. The apparatus of claim 1, wherein the parameters related to the LBT procedure include a LBT counter of connection attempts in the cell.

11. The apparatus of claim 1, wherein the parameters related to the LBT procedure include whether a LBT counter exceeds a configured threshold.

12. The apparatus of claim 1, wherein the parameters related to the LBT procedure include a channel access priority class (CAPC).

13. The apparatus of claim 1, wherein the parameters related to the LBT procedure include a number of autonomous transmissions or retransmissions where the LBT was performed.

14. An apparatus of a base station, the apparatus comprising processing circuitry configured to:
configure transceiver circuitry to transmit a configuration to a user equipment (UE) to perform mobility measurements and log mobility information for reporting to the base station in a self-organizing network (SON) or minimization of drive test (MDT) configuration, wherein the UE performs the mobility measurements on a cell operating on unlicensed channels and logs the mobility information for the cell, wherein the mobility information for the cell operating on the unlicensed channels includes parameters related to a listen before talk (LBT) procedure performed by the UE to access the unlicensed channels;
configure transceiver circuitry to transmit a request to the UE to report the logged mobility information; and
decode, from signaling received from the UE, a report for the logged mobility information including the parameters related to the listen-before-talk (LBT) procedure performed by the UE to access the unlicensed channels of the cell.

15. The apparatus of claim 14, wherein the logged mobility information for the LBT procedure is included in a radio link failure (RLF) report for the SON configuration, wherein the cell operating on the unlicensed channels is a failed cell, a previous primary cell (PCell), or a reconnect cell in a RLF event.

16. The apparatus of claim 14, wherein the logged mobility information for the LBT procedure is included in a connection establishment failure (CEF) report for the SON configuration, wherein the cell operating on the unlicensed channels is a failed cell or a neighbor cell in a CEF event.

17. The apparatus of claim 14, wherein the logged mobility information for the LBT procedure is included in a successful handover (SHO) report for the SON configuration, wherein the cell operating on the unlicensed channels is a source cell or a target cell in a successful handover event.

18. The apparatus of claim 14, wherein the logged mobility information for the LBT procedure is included in a mobility history report for the SON configuration, wherein the cell operating on the unlicensed channels is a visited cell of the UE.

19. The apparatus of claim 14, wherein the logged mobility information for the LBT procedure is included in a log measurement report for the MDT configuration, wherein the cell operating on the unlicensed channels is a serving cell or a neighbor cell of the UE.

20. The apparatus of claim 14, wherein the logged mobility information includes an indication that the cell operates on the unlicensed channels, a channel access mode used by the cell, a RSSI, a RSSI measurement timing configuration, a channel occupancy, and, when the cell is a neighbor cell, whether the cell belongs to a same or different public land mobile network (PLMN).
